(19) United States
(12) Patent Application Publication
(10) Pub. No.: US 2017/0017922 A1
(43) Pub. Date: Jan. 19, 2017

(54) METHOD, APPARATUS AND SYSTEM FOR DETERMINING ACCURACY OF DELIVERIES AND RELATED DOCUMENTATION AT TIME OF DELIVERY

(71) Applicant: Wal-Mart Stores, Inc., Bentonville, AR (US)

(72) Inventors: Timothy D. Wicks, Bella Vista, AR (US); Danyel S. Kaelin, Bella Vista, AR (US); Alex M. Laputz, Centerton, AR (US); Jacqulyn E. Martin, Bentonville, AR (US)

(21) Appl. No.: 15/195,166

(22) Filed: Jun. 28, 2016

Related U.S. Application Data
(60) Provisional application No. 62/192,398, filed on Jul. 14, 2015.

(51) Int. Cl. G06Q 10/08; G06Q 10/06

(52) U.S. Cl. CPC G06Q 10/0838; G06Q 10/06395

(57) ABSTRACT

In some embodiments, systems, apparatus and methods are disclosed for determining accuracy of deliveries and generating automatic response and/or documentation regarding same at the time of delivery. In one form, the solution includes a database containing records pertaining to a business transaction and an order parameter for a particular transaction, an electronic device having a display, a user interface for inputting data regarding a delivery parameter, a network interface for connecting the electronic device to the database, and a control circuit configured to: compare the delivery parameter to the order parameter to determine delivery accuracy; display information relating to the delivery accuracy; document acceptance of the information relating to the delivery accuracy; and generate an automatic response based on the documented acceptance of the information relating to the delivery accuracy.

### CROSS-REFERENCE TO RELATED APPLICATION

This application claims the benefit of U.S. Provisional Application No. 62/192,398, filed Jul. 14, 2015, and is incorporated herein by reference in its entirety.

### TECHNICAL FIELD

This invention relates generally to retail store management and, more particularly, to systems, apparatus and methods for determining accuracy of deliveries, documenting inaccuracies and/or automatically updating system records with respect to same at the time of delivery.

### BACKGROUND

Some primary objectives of conventional retail stores are to provide consumers with the items they need and to do so efficiently so as to maximize sales. An important factor in accomplishing this objective is to have timely and accurate delivery of supplies so that the retail store can continue to operate smoothly and ensure the products desired by consumers are present when consumers shop. Unfortunately, all too often, deliveries of supplies are not accurate and either have shortages or overages that need to be accounted for by store employees (e.g., associates, managers, etc.) thereby distracting the employees from other important tasks that they are responsible for handling. For example, such overages and shortages need to be accounted for when discovered and often times require additional paperwork to make sure the discrepancy is documented and that future shipments are adjusted in view of the discovered shortages and overages.

In addition to creating added burdens associated with such paperwork, delivery inaccuracies also hurt the efficiency of store management because of the amount of follow-up that is often required to ensure that the shortages and overages have been properly handled or accounted for by the store's accounting personnel. In order to have such matters properly addressed, it often requires stores to expend further resources to bring the matter to a conclusion, such as additional personnel time, costs associated with making and providing copies, faxes or other documentation evidencing the shortage or overage, etc. In fact, the common need to provide documentation to back-up the claims of an order or delivery discrepancy may further disrupt normal operations by making the store take photographs and/or maintain paperwork and photographs illustrating the shortage and/or overage. While the documentation task is difficult for all stores to deal with, it becomes an even more daunting task to deal with for larger stores that receive numerous deliveries or shipments per day.

These problems are further exasperated in situations where the store has prepaid for the delivery or shipment. For example, in cases of shortages, the store is then in the unenviable position of having paid for goods and not received them. Thus, every day that passes without the error in the shipment corrected essentially makes the store act as a bank making a no interest loan to the supplier or delivery entity as they have forwarded money to the supplier without getting anything in return. In order to reduce the impact of such a situation, the store may make the delivery discrepancy a high priority issue and pull employees off other tasks to get the situation addressed, thereby, making the inaccurate delivery an even more disruptive event.

Accordingly, it has been determined that a need exists for improved systems, apparatus and methods for determining accuracy of deliveries and related documentation at the time of delivery and for immediately documenting inaccuracies with respect to same so that later evidence to support corrective actions can easily be obtained and provided to the supplier if needed.

### BRIEF DESCRIPTION OF THE DRAWINGS

Disclosed herein are embodiments of systems, apparatuses and methods for using pertaining to improved store management using feedback from vendors.

This description includes drawings, wherein:

FIG. 1 is a flow diagram of a general process in accordance with some embodiments of the invention;

FIG. 2 is a diagram of a general apparatus or system in accordance with several embodiments of the invention;

FIG. 3 is a diagram of an alternate apparatus or system in accordance with other embodiments of the invention; and

FIG. 4 is a flow diagram of an alternate, more specific process in accordance with embodiments of the invention.

Elements in the figures are illustrated for simplicity and clarity and have not necessarily been drawn to scale or to include all features, options or attachments. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking and pursuant to various embodiments, systems, apparatus and methods/processes are provided herein for determining accuracy of deliveries, documenting inaccuracies and/or automatically updating system records with respect to same at the time of delivery to overcome the aforementioned problems with conventional systems, apparatus and methods/processes. For example, in some forms, a delivery confirmation system is provided for determining accuracy of deliveries and generating automatic response and documentation regarding same at the time of delivery. The system may include: a database containing records pertaining to a business transaction and including an order parameter for a particular transaction; an electronic device having a display, a user interface for inputting data regarding a delivery parameter, a network interface for connecting the electronic device to the database, and a control circuit configured to compare the delivery parameter to the order parameter to determine delivery accuracy, display information relating to the delivery accuracy, document acceptance of the information relating to the delivery accuracy, and generate an automatic response based on the documented acceptance of the information relating to the delivery accuracy.

In some forms, the system includes an Electronic Data Interchange (EDI) database containing records of business transactions between a vendor and customer and/or a courier database containing records of a shipment. The EDI database may be used to determine parameters regarding an order or shipment so that they can be immediately checked and verified. If any inaccuracies exist, they may be documented, acknowledged by the deliverer and/or automatically result in the updating of the transaction records between the vendor and customer. For example, in some forms, the EDI database may contain the vendor and customer's transaction details (e.g., what was purchased, how much, sizes, number of items per pack, etc.) and courier details (e.g., weight and size or dimensions of package, etc.). If the delivery received is off on any of these parameters (e.g., off on what supplier claims to have shipped, off on what customer claims to have ordered, off on courier's details on order), the inaccuracies may be documented by an employee and confirmation of these accuracies may be made by the truck driver or other delivery person used by the vendor.

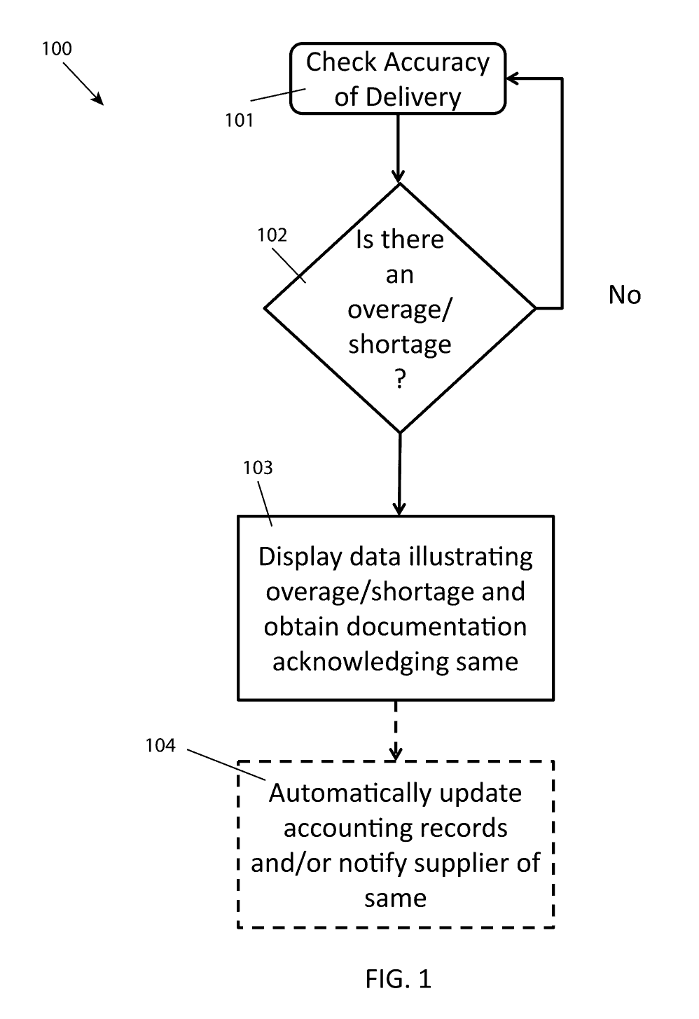

Turning now to the drawings and, in particular, FIG. 1, there is illustrated a flow diagram of a general process in accordance with some embodiments of the invention. The general process is referred to by reference numeral 100 and begins with the step of checking the accuracy of a delivery in step 101. In some forms, this may entail scanning in items delivered via some form of passive identifier, (e.g., quick response (QR) code, bar code (e.g., UPC or GTIN12, EAN or GTIN13, etc.), radio frequency identification (RFID) tag, etc.), or alternatively, could be an active identifier such as product packaging equipped with a near field communication (NFC) tag, active RFID tag, Bluetooth identifier, etc. In some instances, packaging may need to be opened and individual products or packages of product counted.

Regardless of the method used to identify delivered items, the process will preferably include a handheld electronic device that a store associate uses to confirm receipt and accuracy of the delivery or at least to partially perform this task. The handheld device will generate data or input that can then be checked against a database containing delivery parameters to confirm the accuracy of the delivery. In one form, this will be the EDI database mentioned above or another database comprising details of the actual business transaction between the vendor/supplier and customer/store and/or courier details pertaining to the items being delivered.

In step 102, the process determines if the delivery contains any overage or shortage. If no overage/shortage, the process may end or await another delivery to check the accuracy of for the store. In some forms, however, it may be desired to still document the accuracy of the delivery and, thus, the vendor or delivery may be asked to sign a signature recognition device to acknowledge the accuracy of the delivery. A file of this signature may be created as documentation or documentary evidence of the deliverer's acceptance of the accuracy of the order as will be described further below. If an overage/shortage is detected in step 102, the process displays data pertaining to the overage/shortage in step 103 and obtains documentation acknowledging the overage/shortage at the time of delivery, such as the deliverer's signature as described above. In a preferred form, the handheld device will have a touchscreen display that the associate can use to enter input and display details pertaining to any overage/shortage. The deliverer may also use this touchscreen display to sign his or her name acknowledging the overage/shortage. A file of this signature and acceptance of the overage/shortage will be retained for documentation or documentary evidence of the same for later use if needed.

It should be understood that while a single touchscreen display is mentioned as the user interface for the handheld device, in alternate embodiments other types of device configurations may be used to provide the same functionality. For example, in some forms, a non-interactive or non-touchscreen display may be used simply to display data pertaining to the delivery accuracy and any overage/shortage, and a separate user interface such as a signature pad may be used to capture the deliverer's signature and/or the associate's signature if needed or desired. In yet other forms, the handheld devices may be equipped with additional interfaces, such as keypads or voice recognition circuits, and/or components, such as printers, styli, scanners, communication devices, etc., to provide further functionality for the handheld device. For example, a user could use the additional keypad interface or scanner to enter data regarding the shipment or delivery and the printer to print a record or receipt for the delivery with a copy of the deliverer's signature on the receipt. The scanner may be used as part of the order intake processing and/or inventory process for the delivery and/or may be used to scan the identification of the vendor to confirm the vendor is an authorized vendor (e.g., authorized to deliver to the retail establishment). The communication device may be used to communicate with other store associates to assist with the delivery or pick-up the items once checked in for inventorying (e.g., BINing) or stocking purposes.

Turning back to FIG. 1, the process may further include a step 104 for automatically updating records for the transaction to reflect the acknowledged overage/shortage or confirmed accuracy of the order as discussed above. For example, the customer/store's inventory records, accounting records and product management records or future purchase records may be automatically updated to reflect overages/shortages, etc. As a more specific example, in instances of stores with inventory databases, accounting databases and other item management databases, all of these may be automatically updated via process 100 in order to: reflect overages/shortages so that inventory accurately reflects the amount of items in inventory (not what was supposed to be in inventory based on the initial order); so that accounting records are automatically updated (e.g., so store automatically takes credits for overpayments based on shortages in a delivery, store automatically issues credit or payment for overages if the overage items are desired or initiates return if the overage items are not desired); and so that product management records are automatically updated so that future orders are adjusted to reflect any overages/shortages (e.g., ordering more of an item that had a shortage in a prior delivery if desired, ordering less of an item that had an overage in a prior delivery if desired, etc.). The automated step 104 may also entail automatically notifying the supplier/vendor of the overage/shortage and be setup to include the documentation that confirms the overage/shortage if desired.

Thus, the above exemplary process illustrates several advantages of the solution disclosed herein. For example, by capturing the deliverer's acknowledgement of any overage/shortage at the time of delivery, the overall process is sped up and/or made more efficient. In addition, by capturing the deliverer's signature acknowledging the overage/shortage at the time of delivery, the system automatically captures documentation or documentary evidence that supports the overage/shortage which can be used right away to get credit/refund etc. and/or can be called upon at a later time to provide support for such overage/shortage claims made by the customer/store. Still further, the system also can be configured to take automatic action in response to any overage/shortage. For example, the system 100 could be configured to automatically notify the vendor/supplier of the overage/shortage and demand credit or request reimbursement or refunds for the delivery error, or request pick-up for unwanted items, etc. In some forms, the fact the inaccuracy is detected at the time of delivery, the store/customer may send overages back with the deliverer to immediately address overage issues rather than having to deal with them at a later time. It also could automatically update store systems, such as inventory databases, accounting records, product management systems, etc. All of this reduces the amount of time the store has to spend on such delivery inaccuracies and, thus, helps makes the store run more efficient or store management operate more efficiently, and solves the above-mentioned problems with conventional systems.

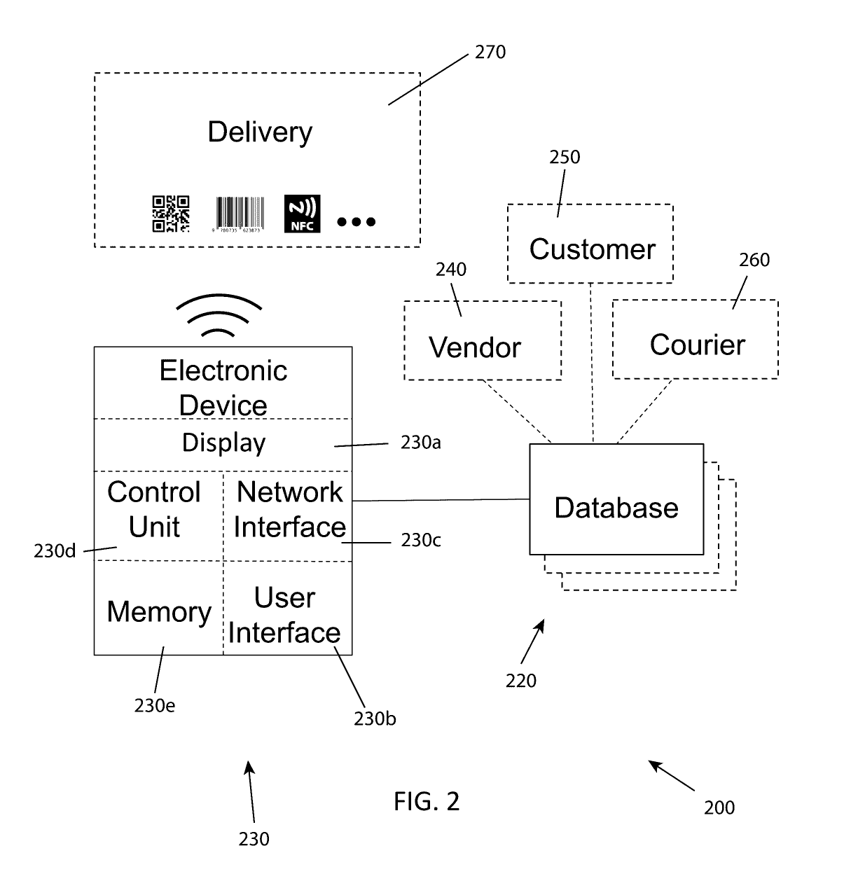

In addition to the methods/processes of FIG. 1, several apparatus and systems are also contemplated and disclosed herein. For example, one exemplary embodiment of a system or apparatus for determining accuracy of deliveries, documenting inaccuracies and/or automatically updating system records with respect to same at the time of delivery is shown in FIG. 2 and referenced generally by reference numeral 200. In the form illustrated, the system or apparatus 200 includes: a database or databases 220 containing records pertaining to a business transaction and including an order parameter for a particular transaction; an electronic device 230 having a display 230a, a user interface 230b for inputting data regarding a delivery parameter, a network interface 230c for connecting the electronic device 230 to the database 220, and a controller or control unit 230d configured to compare the data related to the delivery (e.g., delivery parameter) to the order parameter on database 220 to determine delivery accuracy, display information relating to the delivery accuracy on display 230a, document acceptance of the information relating to the delivery accuracy via user interface 230b, and, in some forms, generate an automatic response based on the documented acceptance of the information relating to the delivery accuracy.

The control unit 214 illustrated in FIG. 2 may generally be one or more computer devices or other electronic devices including a simple circuit or processor. Such a control unit or circuit can comprise a fixed-purpose hard-wired platform or can comprise a partially or wholly programmable platform, such as a microcontroller, an application specification integrated circuit, a field programmable gate array, a server, and so on. These architectural options are well known and understood in the art and require no further description here. In some embodiments, the control unit is configured (for example, by using corresponding programming stored in a separate or integrated memory as will be well understood by those skilled in the art) to carry out one or more of the steps, actions, and/or functions described herein.

It should also be understood that although the apparatus/system 200 illustrates the electronic device 230 having the above-mentioned display 230a, user interface 230b, network interface 230c, control unit 230d, in alternate embodiments the device may more or fewer items or features as well. For example, some forms of device 230 may include additional features, such as internal or on-board memory 230e. In alternate forms, however, the device 230 may rely on external or remote memory storage such as cloud based memory or memory located on another component connectable to device 230 via a network. In yet other forms, any combination of the above-identified components may be utilized and/or certain of these items may be combined or integrated into one (e.g., such as by combining the user interface and display into a touchscreen display).

In the form illustrated, the system 200 includes an Electronic Data Interchange (EDI) database containing records of business transactions between a vendor/supplier 240, a store/customer 250 and/or a courier 260. The EDI database may be used to determine parameters regarding an order or shipment so that they can be immediately checked and verified. Some examples of such parameters include: vendor number or ID, cost, retail, quantity, item number, item or item description, size (e.g., dimensions of product, dimensions of packaging, etc.), weight (e.g., weight of product, weight of product and packaging, etc.), units per package, Purchase Order (PO) number, Invoice number, courier tracking number, courier records relating to shipment, etc. If any inaccuracies exist, they may be documented, acknowledged by the deliverer and/or automatically result in the updating of the transaction records between the vendor 240, customer 250 and/or courier 260. For example, in some forms, the EDI database may contain the vendor and customer's transaction details (e.g., what was purchased, how much, sizes, number of items per pack, etc.) and courier details (e.g., weight and size or dimensions of package, etc.). If the delivery received is off on any of these parameters (e.g., off on what supplier claims to have shipped, off on what customer claims to have ordered, off on courier's details on order), the inaccuracies may be documented by an employee and confirmation of these accuracies may be made by the truck driver or other delivery person used by the vendor. It should also be understood that database 220 may comprise a plurality of separate files each containing data or, alternatively, a single file containing a plurality of data.

Turning back to FIG. 2, in the form illustrated, the system 200 includes a handheld electronic device 230 which a store associate or employee uses to check the accuracy of a shipment or delivery 270. More specifically, the associate or employee uses the device 230 to scan some asset identifier (e.g., passive identifier such as a QR code, bar code, etc., or an active identifier such as an NFC tag, active RFID tag, Bluetooth identifier, etc.). The control unit 230d is configured to check the delivery parameters to those stored on the EDI database 220 and confirm the accuracy of the delivery 270. Any discrepancies or inaccuracies are then displayed to the deliverer on display 230a and the deliverer signs acknowledging the discrepancies or inaccuracies in the delivery 270. In the form illustrated, the display 230a of device 230 is a touchscreen that the deliverer can use to sign his or her name. The device 230 then captures this signature as a file for future use (e.g., use as documentation of overage, shortage, accuracy of delivery, etc.). It should be understood, however, that in alternate forms, alternate signature capture interfaces may be used so long as they are capable of documenting the deliverer's acceptance of the delivery accuracy determination. As mentioned above, in some forms a signature will be required in all instances (e.g., instances where no inaccuracies are found as well as instances with overages or shortages). In other forms, signature may only be required in one or more of such instances (e.g., accurate delivery, inaccurate due to overage, inaccurate due to shortage). It should also be understood that while FIG. 2 illustrates a device 230 equipped with a scanner for scanning in delivery parameters, in alternate forms the device may have other forms of user interfaces and input devices that the user utilizes to key in the delivery details or parameters. In addition, other forms of acceptance/acknowledgement may be used to document the deliverer's acceptance of the information relating to the delivery accuracy or inaccuracy and creating recallable data for same as documentation of the delivery accuracy or inaccuracy.

As mentioned above, in a preferred form, device 230 includes a network interface 230c that the control unit 230d may use to automatically update the business records of the customer to reflect the accuracy of the delivery 270 at the time of delivery. For example, in one form, the device 230 automatically updates the store's inventory management system to reflect the accuracy of delivery 270. This may entail automatically updating accounting records to confirm delivery or reflect any overage/shortage, and may even automatically generate correspondence to the supplier or vendor requesting some action in view of the this delivery assessment (e.g., request refund for shortages, request credit for shortages, make additional payment for overage, request pick-up for return of overage, etc.). For example, in instances where vendor deliveries 270 are pre-paid for by a customer 250, the control unit 230d of the handheld device 230 may be configured to automatically correct billing for the business transaction to account for any overages or shortages based on the information relating to the delivery accuracy. It should also be understood that the automated action features of the system 200 may be a one-sided updating such as only updating the records of the customer/store 250; however, in alternate forms it may be multi-sided in that it can automatically update the records of the customer/store 250, the supplier 240 and/or the courier 260. In some forms of system 200, limited access to the systems of supplier/vendor 240 and courier 260 may even be granted for this purpose. For example, the customer and/or vendor may grant real-time access to transactional documents (e.g., network-based documents or programs that one or both parties have access to) and, thus, system 200 could be used to automatically update transactional documents in real time. Then, when a transaction is completed an invoice is supplied that properly reflects the transaction with any changes or corrections made to same. This differs from the earlier embodiment mentioned in that the earlier embodiment would update the invoice and send the invoice through whatever file transfer format the parties agreed to, such as EDI.

In the form illustrated in FIG. 2, device 230 is provided with internal memory 230e which may be used to temporarily or permanently store the signature files created with the system 200. In alternate forms, however, remote storage medium may be provided remote from device 230 wherein the signature files are kept for later access and use if needed to substantiate an action taken by store 240 (e.g., such as to substantiate or justify a billing correction). The remote storage may be storage on an on-site computer system of the store 240, an off-site computer system of store 240 (e.g., such as at a regional office, distribution warehouse, central processing station, corporate headquarters, etc.), and may store the file or duplicates of the file internally on device 230 and/or externally at on-site or off-site locales.

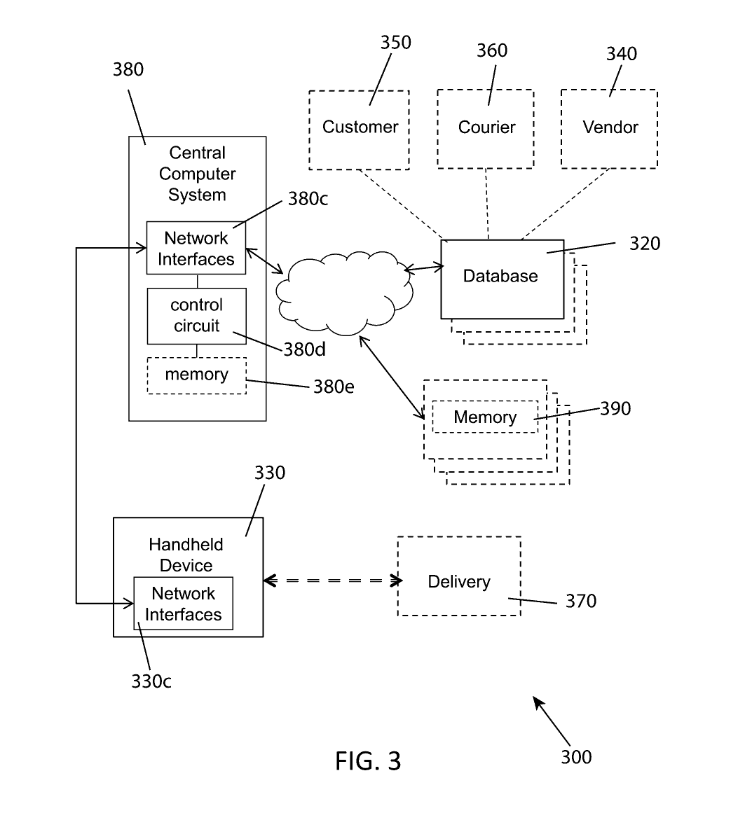

In an alternate form of the solution disclosed herein, the system 200 may include a base unit, such as an onsite central computer system, and a remote handheld unit such as device 230. In this form, the remote handheld unit 230 is used to check-in vendor merchandise associated with the delivery 270 and capture the signature of the deliverer authenticating or confirming the accuracy of the delivery 270. The network interface 230c of device 230 is used to communicate the delivery accuracy information to the central computer system which may simply store the information, automatically act in response to the information or may relay the information on to another store computer system or systems. An example of such a system is illustrated in FIG. 3. For purposes of convenience, item in this embodiment that are similar to those discussed above with respect to FIG. 2 will utilize the same latter two digit reference numeral, but have the prefix 3 instead of 2 to distinguish one embodiment form another.

In the form illustrated in FIG. 3, the system 300 includes a database 320 containing information relating to transactions between vendor 340, customer 350 and/or courier. Unlike the prior embodiment of FIG. 2, however, system 300 further includes a base unit, such as central computer 380, which in this form is a central computer system for an individual store and located on-site at that store facility. The central computer 380 includes a network interface 380c, control unit such as control circuit 380d and, optional, internal memory 380e or other storage medium. Instead of, or in addition to having internal memory 380e or other storage medium, the system 300 may also have remote memory 390 or other storage medium to store information regarding the accuracy of delivery 370. In one form, the system 300 uses handheld device 330 to obtain data regarding delivery 370 and relay that data to the base unit or central computer 380 via the handheld device's network interface 330c (e.g., a first network interface) and the central computer's network interface 380c (e.g., a second network interface). The central computer 380 could further transmit this data to another device located elsewhere if desired and the accuracy check of comparing the delivery data for delivery 370 and the records of EDI database 320 could be performed at any desired device (e.g., performed at one or more of the handheld device 330, the central computer 380 and/or the other remote device located elsewhere). In fact, in some forms portions of the process may be done via the different devices if desired.

In some forms, one or more of the electronic device 330 and central computer 380 may include a display for displaying information relating to the accuracy of delivery 370. As with the prior embodiment, in a preferred form, the handheld device 330 of system 300 will include a touchscreen display which can be used to capture the signature of the deliverer acknowledging the accuracy of the delivery 370 (which could specifically be information regarding the accuracy of the delivery, information relating to the inaccuracies of the delivery or both). In a preferred form, the signature is stored as a signature file on storage medium, such as memory 380e and/or 390 for later access and use if needed to substantiate a corrective action taken such as a billing or accounting correction to account for delivery inaccuracies or discrepancies. The deliverer acknowledgement signatures may be stored as separate signature files or collectively on a single signature file and will preferably be cataloged or indexed for easy search or locating of a particular signature if needed.

In a preferred form, handheld device 330 will communicate with central computer system 380 via wireless communication (e.g., cellular, wi/fi, Bluetooth, etc.) and central computer 380 will communicate with database 320 and any other remote components, such as memory 390, via a network (e.g., local area network, wide area network such as the Internet, etc.). It should be understood, however, that in alternate forms or embodiments different types of networks and communication methods may be used such as personal area networks, wired connections, wireless access points or hotspots, etc.). It also should be understood that in some forms the user of the remote device 330 may be something other than a human, such as in situations where a fully automated delivery intake process is used and automated machines are used to do the delivery inspection, etc.

It should also be understood that the devices or apparatus, systems and/or methods/processes disclosed herein can be altered to accommodate various different types of vendor/store models. For example, such a system could be configured for use at a kiosk with a single electronic device performing all functions of the retailer. Alternatively, a slightly more robust system may be configured for a larger brick and mortar type store. Still other more robust systems may be created for very large retailers with numerous stores in different geographical locations having one or more central processing facilities or headquarters above and beyond individual retail store locations. The system may also be used to confirm the accuracy of deliveries from one store facility to another, such as from a distribution center to a retail store location.

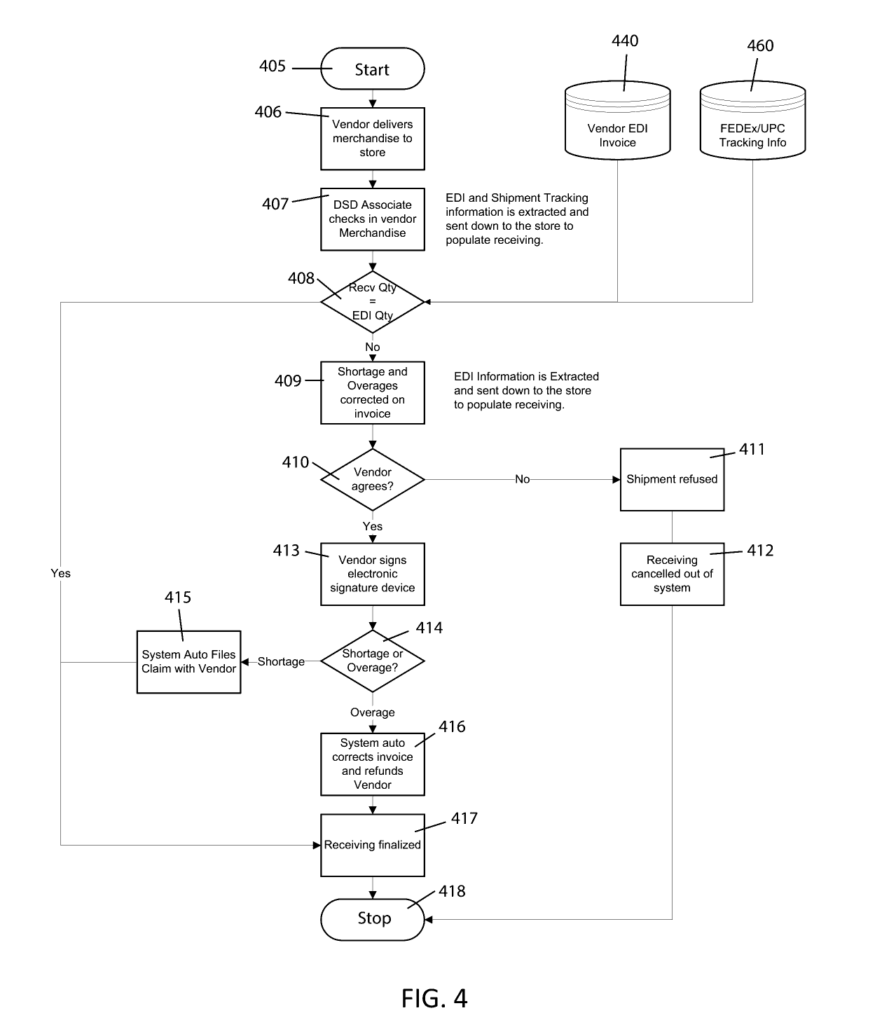

An alternate method or process is illustrated for a slightly more robust retailer in FIG. 4 and is referenced generally by reference numeral 400. In this form, the routine begins at step 405 and awaits a vendor delivery of merchandise to the store at step 406. A direct-to-store delivery or direct store delivery (DSD) associate checks in the vendor merchandise in step 407. In this embodiment, EDI and shipment tracking information is extracted from Vendor EDI database 440 and courier database 460 and transmitted to the store systems of the store receiving the delivery to use as transaction data. A comparison is made between the delivery data and the transaction data in step 409. For example, during this step the system 400 may look to see if the vendor number or ID matches the vendor number/ID, if the cost figure matches the cost figure of the delivery, if the retail figure matches the retail figure of the delivery, if the quantity provided in the delivery data is equal to the quantity of the transaction data, if the item number of the delivery matches the item number in the transactional data, etc. If yes, the routine finalizes the receiving process in step 417 and ends at step 418. If no, system 400 corrects the invoice to reflect any shortages or overages in step 409 and awaits the vendor or deliverer's confirmation of same in step 410. If the vendor or deliverer does not agree to the invoice correction, the shipment is refused in step 411 and any data related to the receiving of the delivery is cancelled out of the system in step 412. Alternatively, if the vendor or deliverer agrees to the invoice correction, the vendor or deliverer signs an electronic signature device in step 413 at the time of the delivery. In step 414, the system then determines whether a shortage or overage was detected. If a shortage was detected, the system automatically takes action, such as by filing a claim with the vendor, in step 415 and then jumps to finalizing the receiving process in step 417 and ends at step 418. If an overage was detected, the system automatically takes action, such as automatically correcting the invoice and pays or refunds the vendor for the overage in step 416. The system then finalizes the receiving process in step 417 and ends in step 418. As mentioned above, the automatic actions taken by the system in response to the overage or shortage determination may be changed to accommodate specific desires of the retailer. For example, in some forms, any overages may be refused by the retailer or store and the system may automatically notify the vendor or supplier that the items over the requested delivery amount have been rejected and returned with the deliverer. In other forms, the automatic action may entail having the vendor re-issue a new invoice reflecting any changes (e.g., overages, shortages, incorrect number of an item, incorrect type of an item, etc.)In yet other forms, the automatic actions may include automatically including a file that is representative of the deliverer's signature acknowledging a delivery inaccuracy or discrepancy (e.g., overage, shortage, damaged item, etc.). In still other forms, the automatic action may entail providing the vendor with a reason certain items were rejected (e.g., damaged product, wrong product or product mislabeled as correct product but is not the correct product, etc.).

While the above-mentioned embodiments have referenced some exemplary items or features, it should be understood that those are merely exemplary items or features and that alternate embodiments may use other items or features of this type. For example, in the above embodiments use of EDI file format is mentioned and EDI databases. It should be understood, however, that EDI is one form of file transfer format and that in alternate embodiments other file transfer formats may be agreed upon and used between the parties (e.g., customers and vendors). Similarly, signature files are mentioned, however, it should be understood that in alternate embodiments, such files may include more than just the vendor's signature. For example, in some forms such files will contain all data needed to legally support the making of a change to the transactional document or to legally prove the deliverer agreed that there was an error with the transactional paperwork (e.g., a shortage or overage, etc.). In some forms, this file will include a copy of the invoice. While in other forms, it may simply include data from the invoice

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A delivery confirmation system for determining accuracy of deliveries and generating automatic response and documentation regarding same at the time of delivery, comprising:
a database containing records pertaining to a business transaction and including an order parameter for a particular transaction;
an electronic device having a display, a user interface for inputting data regarding a delivery parameter, a network interface for connecting the electronic device to the database, and a control circuit configured to:
compare the delivery parameter to the order parameter to determine delivery accuracy;
display information relating to the delivery accuracy;
document acceptance of the information relating to the delivery accuracy; and
generate an automatic response based on the documented acceptance of the information relating to the delivery accuracy.

2. The delivery confirmation system of claim 1 wherein the system determines accuracy of deliveries between customer and vendor and the database is a database of transactional data in a file transfer format agreed upon by the customer and vendor.

3. The delivery confirmation system of claim 1 wherein the database is at least one of an Electronic Data Interchange (EDI) database containing records of business transactions between a vendor and customer and/or a courier database containing records of a shipment.

4. The delivery confirmation system of claim 1 wherein the electronic device is a handheld device with a signature capture interface and documenting acceptance of the information relating to the delivery accuracy comprises capturing a signature with the signature capture interface and creating a signature file for same.

5. The delivery confirmation system of claim 4 wherein the control circuit of the handheld device automatically updates the business transaction records at the time of delivery to reflect the information relating to the delivery accuracy so that accounting records are accurate.

6. The delivery confirmation system of claim 5 wherein vendor deliveries are pre-paid for by a customer and the control circuit of the handheld device automatically corrects billing for the business transaction to account for any overages or shortages based on the information relating to the delivery accuracy.

7. The delivery confirmation system of claim 6 comprising a remote storage medium wherein the signature file is kept for later access and use if needed to substantiate a billing correction.

8. The delivery confirmation system of claim 1 wherein the electronic device comprises a base unit and a remote handheld unit,
the remote handheld unit being used to check-in vendor merchandise associated with the delivery and having a signature capture interface and documenting acceptance of the information relating to the delivery accuracy comprises capturing a signature with the signature capture interface and creating a signature file for same, the remote handheld unit having a first network interface for communicating data relating to the check-in and captured signature to the base unit,
the base unit having a second network interface for communicating with the database and remote handheld unit, and having the control circuit capable of comparing the delivery parameter to the order parameter to determine delivery accuracy.

9. The delivery confirmation system of claim 8 wherein the display is located on at least one of the base unit and remote handheld unit for displaying information relating to the delivery accuracy.

10. The delivery confirmation system of claim 8 wherein the base unit includes a storage medium for storing the signature file for later access and use if needed to substantiate a billing correction and the signature file includes the signature and corrected invoice data showing changes that were made and signed for due to an inaccuracy in the delivery.

11. The delivery confirmation system of claim 8 including a remote storage medium for storing the signature file for later access and use if needed to substantiate a billing correction.

12. A computer implemented method for determining accuracy of deliveries and generating automatic response and documentation regarding same at the time of delivery, comprising:
comparing, by a control circuit, a delivery parameter to the order parameter via the control circuit to determine delivery accuracy, the delivery parameter retrieved from a database accessible by the control circuit and the database including records pertaining to a business transaction and including an order parameter for a particular transaction ;
displaying, by a control circuit, information relating to the delivery accuracy on the user interface;
documenting, by a control circuit, acceptance of the information relating to the delivery accuracy by capturing a signature via the user interface; and
generating, by a control circuit, an automatic response based on the documented acceptance of the information relating to the delivery accuracy.

13. The method of claim 12 wherein generating the automatic response comprises storing the captured signature as a file on a storage medium.

14. The method of claim 12 wherein generating the automatic response comprises automatically updating the business transaction records at the time of delivery to reflect the information relating to the delivery accuracy and ensure accurate accounting records.

15. The method of claim 12 wherein the database is at least one of an EDI database containing records of business transactions between a vendor and customer and/or a courier database containing records of a shipment between vendor and customer, and wherein automatically updating the business transaction records at the time of delivery comprises automatically correcting billing for the business transaction to account for any overages or shortages based on the information relating to the delivery accuracy.

16. An apparatus for determining accuracy of deliveries between a vendor and customer at the time of delivery, comprising:
a control circuit; and
a non-transitory computer readable memory storing a set of instructions executable by the control circuit and configured to cause the control circuit to perform the steps of:
comparing a delivery parameter to an order parameter relating to a business transaction between the vendor and customer to determine delivery accuracy; and
automatically updating business transaction records based on the determined delivery accuracy.

17. The apparatus of claim 16 wherein the set of instructions executable by the control circuit and configured to cause the control circuit to perform steps further include and cause the control circuit to perform the step of generating evidence of the delivery accuracy at the time of delivery.

18. The apparatus of claim 17 further comprising a display and signature capturing interface in communication with the control circuit, wherein generating evidence of the delivery accuracy comprises displaying information relating to the delivery accuracy on the display and capturing a signature via the signature capturing interface to form the generated evidence of the delivery accuracy at the time of delivery.

19. A delivery confirmation system for determining accuracy of deliveries and automatically updating business transaction records regarding same at the time of delivery, comprising:
means for storing records pertaining to a business transaction including an order parameter for a particular transaction; and
means for comparing a delivery parameter of a delivery to the order parameter to determine delivery accuracy and automatically update the business transaction records to reflect the delivery accuracy.

20. The delivery confirmation system of claim 19 further comprising means for generating evidence of the delivery accuracy at the time of delivery.
